(19) United States
(12) Patent Application Publication
(10) Pub. No.: US 2010/0087146 A1
(43) Pub. Date: Apr. 8, 2010

(54) METHOD AND DEVICE FOR PERFORMING SHORT RANGE WIRELESS COMMUNICATION OF MOBILE TERMINAL

(75) Inventors: Sang Wook HAN, Gyeonggi-do (KR); Yong Seong JEONG, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/573,330

(22) Filed: Oct. 5, 2009

(30) Foreign Application Priority Data
Oct. 6, 2008 (KR) 2008-97882

(51) Int. Cl. H04B 7/005

(52) U.S. Cl. 455/41.2

(57) ABSTRACT

A method and device for performing short range wireless communication of a mobile terminal reduces a time period of searching for terminals for connection. A short wireless communication distance can be extended by switching to/from a directional antenna and an omni-directional antenna of the mobile terminal according to a user setting. The method of performing short range wireless communication in a mobile terminal including a directional first antenna, an omni-directional second antenna, and a switch unit for switching the first antenna and the second antenna includes: activating the first antenna and searching for connectable terminals, when a short range wireless communication function is activated; and forming a communication channel with the found terminal, if a connectable terminal is found after activating the first antenna.

### CLAIM OF PRIORITY

This application claims the benefit of priority from Korean Patent Application No. 10-2008-0097882 filed in the Korean Intellectual Property Office on Oct. 6, 2008, the contents of which are incorporated herein by reference in its entirety.

### BACKGROUND OF THE INVENTION

1. Field of the Invention

The present invention relates to a method and device for performing short range wireless communication of a mobile terminal. More particularly, the present invention relates to a method and device for performing short range wireless communication of a mobile terminal and antennas that can be used for quickly optimizing transmissions.

2. Description of the Related Art

In general, as an ever-increasing number of functions are added to a mobile terminal, the mobile terminal, more than ever before, can perform complex tasks far beyond voice communication. Nowadays, the mobile terminal provides various functions, such as message transmission and reception, wireless Internet reception, phonebook management, schedule management, photographing, audiovisual communication, recording, and short range wireless communication, in addition to a general communication function.

In order to provide the short range wireless communication function, the mobile terminal includes a short range wireless communication module and an antenna. In general, the antenna in a mobile terminal is classified as either an omni-directional antenna, which can transmit and receive a signal in all directions or, a directional antenna, which can transmit and receive a signal only in a specific direction.

When forming a short range wireless communication channel using the omni-directional antenna, the omni-directional antenna searches for terminals in all directions and thus a time period for searching for the terminals is extended. However, the omni-directional antenna has a communication distance shorter than that of the directional antenna.

When forming a short range wireless communication channel using the directional antenna, a maximum communication distance with another terminal positioned at a specific direction is relatively longer than that when forming a short range wireless communication channel using the omni-directional antenna, thereby favoring the directional antenna. In addition, the directional antenna cannot form a communication channel with terminals positioned at other directions (hence effective for one direction).

### SUMMARY OF THE INVENTION

The present invention provides a method and device for performing short range wireless communication by a mobile terminal that can quickly search for other terminals for forming a communication channel, and that can also extend a communication distance by switching a directional antenna and an omni-directional antenna according to user setting.

In accordance with an exemplary aspect of the present invention, a short range wireless communication device of a mobile terminal preferably includes: a directional first antenna; a omni-directional second antenna; a switch unit for switching a connection with one of the first antenna and the second antenna according to a predetermined control signal; a short range wireless communication unit for performing a short range wireless communication function using the connected one of the first antenna and the second antenna that is connected through the switch unit; and a controller for controlling transmission of a control signal to the switch unit for activating the first antenna, when the short range wireless communication unit is activated.

In accordance with another exemplary aspect of the present invention, a method of performing short range wireless communication in a mobile terminal including a directional first antenna, a omni-directional second antenna, and a switch unit for switching between the first antenna and the second antenna includes: activating, when a short range wireless communication function is activated, the first antenna and searching for connectable terminals; and forming, if a connectable terminal is found after activating the first antenna, a communication channel with the found terminal.

### BRIEF DESCRIPTION OF THE DRAWINGS

The exemplary objects, features and advantages of the present invention will become more apparent from the following detailed description in conjunction with the accompanying drawings, in which:

FIG. 1 is a block diagram illustrating an exemplary configuration of a mobile terminal according to an exemplary embodiment of the present invention;

FIG. 2 is a diagram illustrating a switch unit in the mobile terminal of FIG. 1;

FIGS. 3A and 3B are diagrams illustrating an exemplary radiation direction display method of a directional antenna in the mobile terminal of FIG. 1;

FIG. 4 is a flowchart illustrating exemplary operation of a method of performing short range wireless communication in a mobile terminal according to another exemplary embodiment of the present invention; and

FIG. 5 is a diagram illustrating a short range wireless communication network for performing the method of FIG. 4.

### DETAILED DESCRIPTION

Hereinafter, exemplary embodiments of the present invention are described in detail with reference to the accompanying drawings. The same reference numbers are used throughout the drawings to refer to the same or like parts. The views in the drawings are schematic views only, and are not intended to be to scale views and/or correctly proportioned. Detailed descriptions of well-known functions and structures incorporated herein may be omitted to avoid obscuring appreciation of the subject matter of the present invention by a person of ordinary skill the art.

While the present invention may be embodied in many different forms, specific exemplary embodiments of the present invention are shown in drawings and are described herein in detail, with the understanding that the present disclosure is to be considered as an exemplification of the principles of the invention and is not intended to limit the invention to only the specific embodiments illustrated.

In the following description, for convenience of description, a mobile terminal according to an exemplary embodiment of the present invention is described as a mobile communication terminal: however, the present invention is not limited thereto. That is, the mobile terminal according to the present exemplary embodiment may be any terminal including a short range wireless communication function, and may be an information and communication device or a multimedia device, including but in no way limited to such as a mobile communication terminal, mobile phone, personal digital assistant (PDA), smart phone, International Mobile Telecommunication 2000 (IMT-2000) terminal, code division multiple access (CDMA) terminal, wideband code division multiple access (WCDMA) terminal, Global System for Mobile Communication (GSM) terminal, general packet radio service (GPRS) terminal, universal mobile telecommunication service (UMTS) terminal, portable multimedia player, digital broadcasting terminal, and applications thereof.

A “radiation range” is a range within which an antenna can transmit and receive electric waves. In general, a directional antenna has a radiation range in a predetermined specific direction, and an omni-directional antenna has a radiation range in all directions. That is, the directional antenna can receive electric waves incoming from a specific direction, and transmit electric waves in a specific direction, whereas the omni-directional antenna can receive electric waves input from all directions, and transmit electric waves in all directions. Hereinafter, a radiation range of the directional antenna is referred to as a first radiation range, and a radiation range of the omni-directional antenna is referred to as a second radiation range.

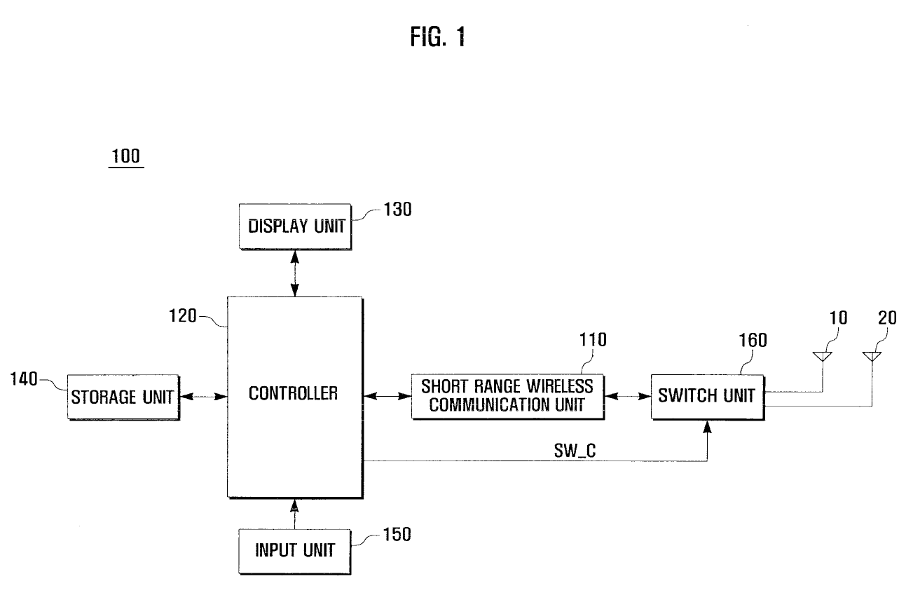

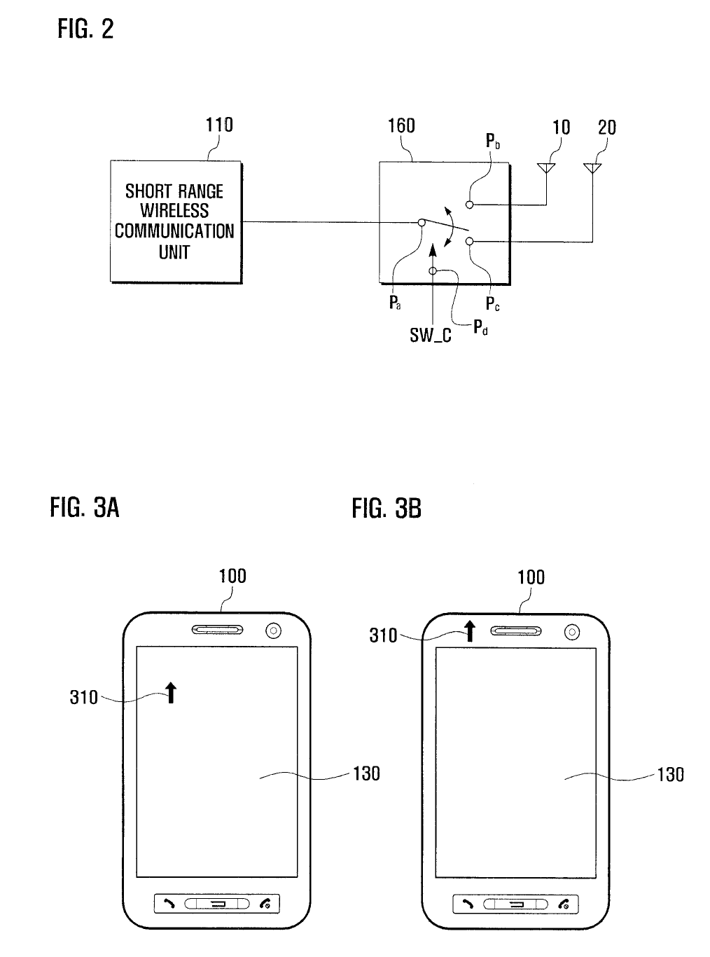

FIG. 1 is a block diagram illustrating a configuration of a mobile terminal according to an exemplary embodiment of the present invention. FIG. 2 is a diagram illustrating a switch unit preferably arranged in the mobile terminal of FIG. 1. FIGS. 3A and 3B are diagrams illustrating a radiation direction display method of a directional antenna in the mobile terminal of FIG. 1.

Referring now to FIGS. 1 to 3B, the mobile terminal 100 includes a short range wireless communication unit 110, controller 120, display unit 130, storage unit 140, input unit 150, switch unit 160, first antenna 10, and second antenna 20.

The first antenna 10 and the second antenna 20 are antennas for performing a short range wireless communication function, wherein one of the first antenna 10 and the second antenna 20 is formed as a directional antenna and the other antenna is formed as an omni-directional antenna. Hereinafter for this example, the first antenna 10 comprises a directional antenna and the second antenna 20 comprises an omni-directional antenna. The first antenna 10 and the second antenna 20 are connected to the switch unit 160 and are selectively activated according to a control signal SW_C input to the switch unit 160. That is, the first antenna 10 and the second antenna 20 are selectively connected to the short range wireless communication unit 110 through the switch unit 160 according to the control signal SW_C. The first antenna 10 and the second antenna 20 can be formed, for example, in a chip antenna.

The switch unit 160 is preferably switched according to the predetermined control signal SW_C received from the controller 120 for connection with one of the first antenna 10 and the second antenna 20, and connects one of the first antenna 10 and second antenna 20 to the short range wireless communication unit 110.

Referring now to FIG. 2, the switch unit 160 includes a first terminal Pa connected to the short range wireless communication unit 110, a second terminal Pb connected to the first antenna 10, a third terminal Pc connected to the second antenna 20, and a fourth terminal Pd for inputting the control signal SW_C. In the switch unit 160, the first terminal Pa is connected to one of the second terminal Pb and the third terminal Pc according to the control signal SW_C. Specifically, when the control signal SW_C comprises a signal, for example, having a voltage higher than a predetermined reference voltage (hereinafter, referred to as a high voltage signal), for activating the first antenna 10, the first terminal Pa is connected to the second terminal Pb, and when the control signal SW_C is a signal, for example a signal having a voltage lower than a predetermined reference voltage (hereinafter, referred to as a low voltage signal), for activating the second antenna 20, the first terminal Pa is connected to the third terminal Pc.

Alternatively, when the control signal SW_C comprises a high voltage signal, the first terminal Pa is connected to the third terminal Pc and the second antenna 20 is activated, and when the control signal SW_C comprises a low voltage signal, the first terminal Pa is connected to the second terminal Pb and the first antenna 10 is activated.

The short range wireless communication unit 110 preferably transmits and receives a wireless signal by forming a communication channel with other terminals existing within a predetermined range by the control of the controller 120. Particularly, in the present exemplary embodiment, the short range wireless communication unit 110 performs a short range wireless communication function using one of the first antenna 10 and second antenna 20 by switching the connection of switch unit 160 to a desired antenna. The short range wireless communication unit 110 can use at least one of type of protocol for short range transmissions, including but not limited to Bluetooth, Zigbee, ultra wide band (UWB), and wireless local area network (LAN) systems.

Referring now to FIG. 1, the display unit 130 displays, for example, user data input by a user, function setting information, and various information provided to a user as well as various menu screens of the mobile terminal 100. The display unit 130 may include one of a liquid crystal display (LCD) and an organic light emitting diode (OLED) display, just to name a few examples of a possible screen. Further, when the display unit 130 is formed with a touch screen, the display unit 130 can be operated as an input unit in addition to serving as a display unit. Particularly, in the present exemplary embodiment, when performing short range wireless communication using the first antenna 10, a direction indicator 310 indicates a radiation direction of the first antenna 10. The direction indicator 310 may be displayed at one side of a display screen of the display unit 130, as shown in FIG. 3A, or alternatively, the direction indicator 310 may be formed at one side of an external body of the mobile terminal 100 when manufacturing the mobile terminal 100, as shown in FIG. 3B. Further, the display unit 130 can display the status of an activated antenna of the first antenna 10 and the second antenna 20 at one side of the display unit 130 by using an icon for the control of the controller 110.

The input unit 150 preferably includes a plurality of input keys and function keys for inputting numeral and character information and setting various functions. The function keys may preferably include direction keys, side keys, and hotkeys that are set to perform a specific function. For example, the input unit 150 may include a function key for activating a short range wireless communication function.

The storage unit 140 preferably stores user data as well as a program necessary for executing a function according to the present exemplary embodiment. The storage unit 140 may also preferably include a program area and a data area.

The program area can also store, for example, a program for controlling general operations of the mobile terminal 100, an operating system for booting the mobile terminal 100, an application program for reproducing multimedia contents, and an application program for operating option functions, for example a photographing function, sound reproduction function, image or moving picture reproduction function, and short range wireless communication function of the mobile terminal 100, just to name a few possibilities. Particularly, in the present exemplary embodiment, the program area stores a program for controlling a switching operation of the switch unit 160.

The data area is an area for storing data generated according to use of the mobile terminal 100 and may store, for example, a phonebook, audio data, and information corresponding to user data. Particularly, in the present exemplary embodiment, the data area stores data related to the direction indicator 310 for notifying a user of a radiation direction of the first antenna 10. The direction indicator 310 may have an arrow shape for representing a specific direction, as shown in FIG. 3A. However, a shape of the direction indicator 310 is not limited thereto. For example, the direction indicator 310 may be displayed in a directional compass shape, just to mention one possible non-limiting example.

The controller 120 controls general operations of the mobile terminal 100 and a signal flow between elements of the mobile terminal 100 and performs a data processing function. Particularly, in the present exemplary embodiment, the controller 120 generates the control signal SW_C for controlling a switching operation of the switch unit 160 and transmits the control signal SW_C to the fourth terminal Pd of the switch unit 160. The control signal SW_C may be a high voltage signal or a low voltage signal, as described in detail above.

When connectable terminals are found within a radiation range of the first antenna 10 (a first radiation range) or a radiation range of the second antenna 20 (a second radiation range), the controller 120 forms a communication channel with the found terminals. Specifically, when a signal for activating the short range wireless communication unit 110 is input, the controller 120 first searches for connectable terminals within the first radiation range by activating the first antenna 10. For example, the controller 120 generates a control signal SW_C for activating the first antenna 10 and for transmitting the control signal SW_C to the fourth terminal Pd of the switch unit 160. The control signal SW_C may comprise one of a high voltage signal and a low voltage signal according to user setting.

If no connectable terminals are found within the first radiation range, the controller 120 controls to display a message notifying the user of the search result. The message may comprise an alphanumeric character message, such as “No connectable terminal is found in a present direction. Please change the direction”, or can be a symbol, or flash a light on and off. An audible indication could be provided. Thereafter, the user can perform again a process of searching for another terminal by changing a direction of the mobile terminal 100. In this case, the controller 120 controls to display the direction indicator 310 for indicating a radiation direction of the first antenna 10 at one side of the display unit 130.

Further, if no connectable terminals are found within the first radiation range within a preset time period after activating the first antenna 10, the controller 120 searches for connectable terminals within the second radiation range by activating the second antenna 20. For this, the controller 120 transmits a control signal SW_C to the switch unit 160 for activating the second antenna 20.

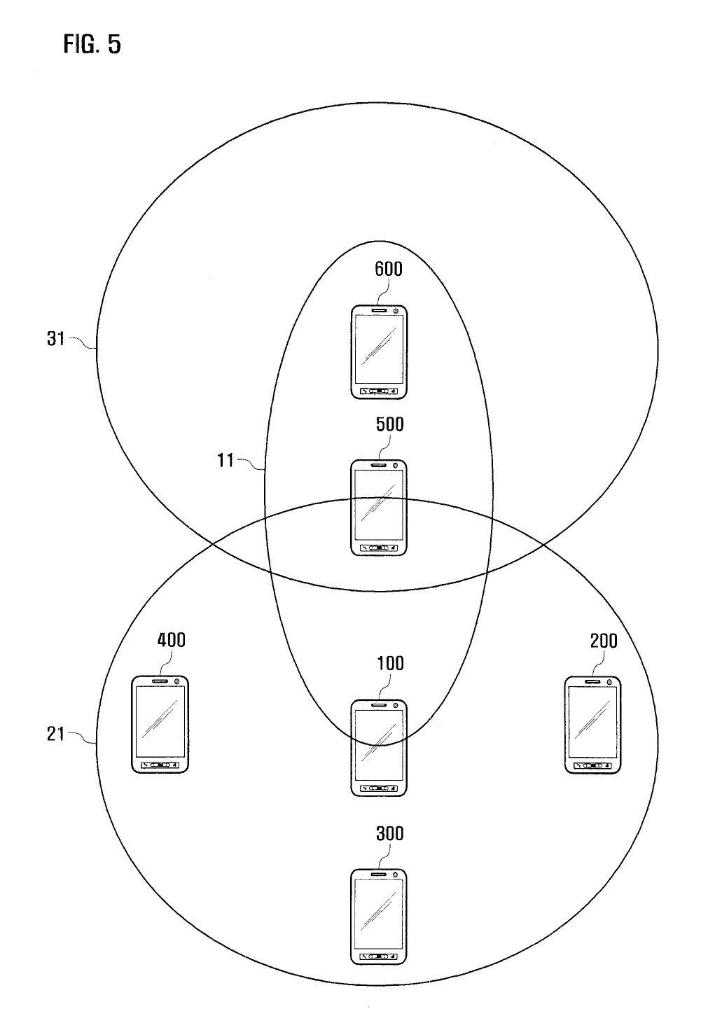

If no connectable terminals are found within the second radiation range, the controller 120 then transmits a message in a specific direction using the directional first antenna 10. This transmission is performed using a characteristic of a directional antenna of transmitting a wireless signal relatively further than an omni-directional antenna using the same signal power because a directional antenna concentrates and radiates wireless signals in one direction. In this particular case, the controller 120 may transmit a message including the phone number of the mobile terminal 100 and requesting a receiving mobile terminal to use a directional antenna. The reason for transmitting such a message is because the mobile terminal 100 may not be positioned within a short range wireless communication range of another terminal. This operation is described later in detail with reference to FIG. 5.

Although not shown in FIG. 1, the mobile terminal 100 may further include elements having additional functions, such as a camera module for photographing an image or a moving picture, a broadcasting reception module for receiving digital broadcasting, an audio signal output device such as a speaker, a sound signal input device such as a microphone, and a digital sound source reproduction module such as an MP3 module, just to name a few possible additional functions.

A method of performing short range wireless communication in the mobile terminal 100 according to a present exemplary embodiment is described hereinafter in combination with a flowchart.

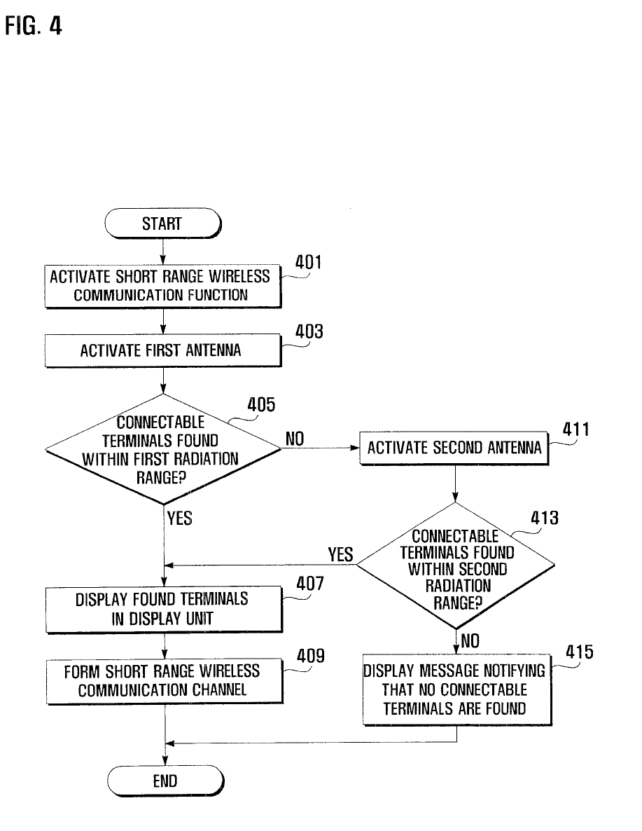

FIG. 4 is a flowchart illustrating exemplary operational steps of a method for performing short range wireless communication in the mobile terminal 100 according to another exemplary embodiment of the present invention. FIG. 5 is a diagram illustrating a non-limiting example a short range wireless communication network for performing the method of FIG. 4.

For convenience of description, the mobile terminal 100 used in the method of the present exemplary embodiment is referred to hereinafter as the “first terminal 100”.

Referring now to FIGS. 1, 4 and 5, at step (401) the controller 120 detects a signal for activating a short range wireless communication function. Here, the short range wireless communication may be performed through at least one of, for example, Bluetooth, Zigbee, ultra wide band (UWB), and wireless local area network (LAN) systems.

At step (403), the controller 120 activates the first antenna 10 to search for connectable terminals. More particularly, this activation occurs when the controller 120 generates a control signal for activating the first antenna 10 and transmits the control signal to the switch unit 160. The control signal may be a high voltage signal or a low voltage signal, according to a designer's specification. The controller 120 controls display of the direction indicator 310 for indicating a radiation direction of the first antenna 10 at one side of the display unit 130.

As shown in FIG. 5, the first antenna 10 (FIG. 1) is a directional antenna that has a first radiation range 11 formed only in a specific direction. For example, when the first antenna 10 is activated, the first terminal 100 cannot find a second terminal 200, a third terminal 300, and a fourth terminal 400, and can find only a fifth terminal 500 and a sixth terminal 600. The first terminal 100 may transmit a signal for requesting to connect a communication channel with the sixth terminal 600. However, in the case where the sixth terminal 600 uses an omni-directional antenna, the first terminal 100 cannot receive a response signal to the request signal because the first terminal 100 is positioned outside a radiation range 31 of the omni-directional antenna of the sixth terminal 600 and does not receive a signal, or the signal is so weak that it is unable to be processed. Thus, the communication is one way, from the first terminal 100 to the sixth terminal 600. Therefore, the first terminal 100 transmits a message including its phone number or a message in a direction of the sixth terminal 600 requesting the sixth terminal 600 to change to a directional antenna, in order to be able to receive communication from the sixth terminal 600.

Again referring to FIG. 4, at step (405) the controller 120 determines whether connectable terminals are found within the first radiation range 11. If connectable terminals are found within the first radiation range 11, the controller 120 controls to display the found terminals in the display unit 130 (407). The controller 120 forms a short range wireless communication channel with a terminal selected by the user (409).

If no connectable terminals are found within the first radiation range 11 at step 405, the controller 120 then activates the second antenna 20 to further search for connectable terminals (411). For this, the controller 120 generates a control signal for activating the second antenna 20 and transmits the control signal to the switch unit 160. The control signal may be, for example, a high voltage signal or a low voltage signal according to a designer's intention. As shown in FIG. 5, the second antenna 20 is an omni-directional antenna and has a second radiation range 21.

At step (413), the controller 120 determines whether any connectable terminals are found within the second radiation range 21. If no connectable terminals are found within the second radiation range 21, the controller 120 controls to display a message notifying that no connectable terminals are found (415).

However, at step (413) if connectable terminals are found within the second radiation range 21, the process continues at step 407 and the controller 120 controls the display unit 130 to display indication of the found terminals, then forms a short range wireless communication channel with a terminal selected by the user at step 409.

Although not shown in FIG. 4, if no connectable terminals are found within the first radiation range 11 at step 405, the controller 120 controls the display unit 130 to display a message requesting the user to change a direction of the first terminal 100 before activating the second antenna 20. In this case, the user can continue to perform the process of searching for connectable terminals by checking the direction indicator 310 displayed in the display unit 130 for indicating the radiation direction of the first antenna 10 and by changing a direction of the first terminal 100 accordingly. In fact, in the case where the first antenna 10 comprises a directional antenna and the second antenna 20 comprises an omni-directional antenna, changing a direction/orientation of first terminal 100 may find connectable terminal(s) that might not be found by the act of switching to the second antenna 20, due to the range limitations of the second antenna 20.

Further, the controller 120 controls the display unit 130 to display an icon notifying the user as to which one of the first antenna 10 and the second antenna 20 is presently activated.

As described above, according to the present invention, when a short range wireless communication function is activated, a first terminal searches for other terminals in a specific direction by preferentially activating a directional first antenna, thereby reducing a searching time period of searching for terminals. This preferential activation occurs is performed because a user generally knows locations of other terminals for forming a communication channel.

Further, if the user knows a position of a terminal to form a communication channel, by using a directional antenna using the same power, a communication distance can be relatively further extended than by using an omni-directional antenna. For this reason, the first terminal can transmit terminal information through the directional antenna, for example a message including its phone number or a message requesting the other terminal to change to a directional antenna. If the other terminal includes a directional antenna, having received the message requesting to change to a directional antenna, the terminal can form a communication channel with the first terminal, which lies outside a radiation range of the omni-directional antenna of the other terminal, by changing to the directional antenna. However, if the other terminal does not include a directional antenna, the terminal can output a message notifying that a request for forming a communication channel together with a phone number of the first terminal is received.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims. For example, while two antennas are shown in the exemplary embodiments, it is within the spirit and scope of the invention that other types/quantities of antenna arrangements that are connectable via the switching unit can be used.

What is claimed is:

1. A short range wireless communication device of a mobile terminal comprising:
a directional first antenna;
an omni-directional second antenna;
a switch unit for switching a connection to one of the first antenna and the second antenna according to a predetermined control signal;
a short range wireless communication unit for performing a short range wireless communication function using a connected one of the first antenna and the second antenna that is connected through the switch unit; and
a controller for controlling transmission of a control signal for activating said one of the first antenna and the second antenna to the switch unit, when the short range wireless communication unit is activated.

2. The short range wireless communication device of claim 1, wherein the first antenna and the second antenna are formed in a chip antenna.

3. The short range wireless communication device of claim 1, wherein the controller initially searches for connectable terminals within a radiation range of the first antenna and forms a communication channel with the found terminal, when a connectable terminal is found.

4. The short range wireless communication device of claim 3, wherein the controller controls a display unit of the mobile terminal to display one of a message or indication requesting a change of a direction of the mobile terminal when no connectable terminal is found within the radiation range of the first antenna, and wherein the controller further searches for connectable terminals in a changed direction according to a user request.

5. The short range wireless communication device of claim 3, wherein the controller transmits a message including a phone number of the mobile terminal in a specific direction using the first antenna requesting that a terminal, which is within receiving range of the short range wireless communication device but not within range to transmit an acknowledgement, changes transmission to a directional antenna, when no connectable terminal responds to the transmission by the first antenna of the short range wireless communication device.

6. The short range wireless communication device of claim 3, wherein the controller transmits to the switch unit a control signal for activating the second antenna to the switch unit, when no connectable terminal is found within the radiation range of the first antenna.

7. The short range wireless communication device of claim 6, wherein the controller searches for connectable terminals within a radiation range of the second antenna and forms a communication channel with the found terminal, when a connectable terminal is found.

8. The short range wireless communication device of claim 6, wherein when no connectable terminal is found within the radiation range of the second antenna, the controller controls a display unit of the mobile terminal to display one of a message or indication notifying that no connectable terminal is found.

9. The short range wireless communication device of claim 1, further comprising a display unit for displaying an icon corresponding to an activated antenna of the first antenna and the second antenna at one side of the display unit.

10. The short range wireless communication device of claim 9, wherein the display unit displays a direction indicator for indicating, when the first antenna is activated, a radiation direction of the first antenna at one side of a screen.

11. The short range wireless communication device of claim 1, wherein the short range wireless communication unit uses at least one of Bluetooth, ZigBee, ultra wide band (UWB), and wireless local area network (LAN) systems.

12. A method of performing short range wireless communication in a mobile terminal that includes a directional first antenna, an omni-directional second antenna, and a switch unit for switching the first antenna and the second antenna, said method comprising:
activating the first antenna and searching for connectable terminals when a short range wireless communication function is activated; and
forming a communication channel with the found terminal when a connectable terminal is found after activating the first antenna.

13. The method of claim 12, further comprising:
displaying an indication requesting a change of a direction of the mobile terminal when no connectable terminal is found after activating the first antenna; and
searching further for connectable terminals after a direction of the mobile terminal is changed.

14. The method of claim 12, further comprising transmitting a message including a phone number of the mobile terminal in a specific direction through the first antenna when no connectable terminal is found after activating the first antenna.

15. The method of claim 12, further comprising:
activating the second antenna and searching for connectable terminals when no connectable terminal is found after activating the first antenna; and
forming a communication channel with the found terminal, when a connectable terminal is found after activating the second antenna.

16. The method of claim 15, further comprising displaying one of a message or indication notifying that no connectable terminal is found, when no connectable terminal is found after activating the second antenna.

17. The method of claim 12, further comprising displaying an icon representing the presently activated one of the first antenna and the second antenna.

18. The method of claim 12, further comprising displaying a direction indicator for indicating, when the first antenna is activated, a radiation direction of the first antenna.

19. The method of claim 12, wherein the short range wireless communication uses at least one of Bluetooth, ZigBee, UWB, and wireless LAN systems.

20. The method of claim 14, wherein the message includes requesting that a terminal, which is within receiving range of the short range wireless communication device but not within range to transmit an acknowledgement, changes transmission to a directional antenna, when no connectable terminal responds to the transmission by the first antenna.
